(19) United States
(12) Patent Application Publication
(10) Pub. No.: US 2004/0013048 A1
(43) Pub. Date: Jan. 22, 2004

(54) Timing device

(76) Inventor: Steven T. Adamy, Princeton, NJ (US)

Correspondence Address: Stephen B. Shear, Esq., Associate General Counsel And Patent Counsel, Church & Dwight Co., Inc., 469 North Harrison Street, Princeton, NJ, 08543-5297, US

(21) Appl. No.: 10/196,844

(22) Filed: Jul. 16, 2002

(51) Int. Cl. G04C 1/00

(52) U.S. Cl. 368/327

(57) ABSTRACT

A timing device for visually determining the passage of a preselected period of time including a tube containing first and second liquids in contact with each other wherein one of the first or second liquids diffuses into the other liquid in a manner which results in an observable change of property which is related to the desired preselected period of time.

### FIELD OF THE INVENTION

The present invention is generally directed to a timing device for visually determining the passage of a preselected period of time which is applicable to a wide variety of consumer products, especially for products which have an extended shelf or use life and for which it is desirable to know when the product must be replaced or rejuvenated. The timing device can be attached to or incorporated in typical packaging employed for consumer products.

### BACKGROUND OF THE INVENTION

Consumer products including food products, cleaning products, deodorizers and the like have a shelf life determined by the length of time the components of the product resist change to environmental influences. For example, food products have a given shelf life based on their ability to resist chemical or physical changes due to contact with air, heat and other influences in the environment. Many consumer products are date stamped to provide the user with an indication of the shelf life of the product. The shelf life may be relatively short such as a few days or may be relatively lengthy such as a few months. Date stamping of consumer products provides the user with some indication when the product may no longer be useful for its intended purpose.

Quite often, date stamps are printed inconspicuously on the product package. It is sometimes difficult to read the date stamp and in some cases even to find the date stamp because it may be printed anywhere on the package. Date stamping is particularly problematic for products which have a relatively long shelf life because such products tend to get stored in obscure recesses of a storage area, such as a food cabinet or refrigerator. If the product is not used often, the consumer is often unaware that the expiration date is shortly forthcoming or has even passed.

There have been attempts to provide a visible indication of when the useful life of a product has expired. So called “life time indicators” are employed for food products such as disclosed in U.S. Pat. Nos. 2,671,028; 3,751,382; and 3,942,467. These indicators typically work through chemical reactions initiated or increased in rate by exposure to high temperatures. Other lifetime indicators rely on diffusion of a component through a traditional wick or membrane as disclosed in U.S. Pat. Nos. 3,414,415; 3,479,877 and 3,768,976, each of which is incorporated herein by reference.

Examples of such products include, for example, the Oral-B toothbrush indicator which is based on the diffusion of a dye out of the bristles. When the color of a select group of bristles disappears, the user is aware that the toothbrush may or should be discarded and replaced. Another example is the Glade Neutralizer which is a deodorizer product having a timer based on the evaporation of a solvent from a polymer gel and subsequent shrinkage of the gel.

The timing indicators mentioned above suffer from one or more disadvantages which makes their universal applicability to a wide range of packaged products problematical. Such disadvantages include a) the timing mechanism is part of the product (e.g. a deodorizer) and is therefore limited to employment with that product or that class of products, b) the timing mechanism is inaccurate or cannot be controlled to accommodate a wide range of product shelf lives, c) the timing mechanism is expensive and/or d) has a limited range of measurement.

WO 00/70412 published on Nov. 23, 2000 discloses a timing device which overcomes at least some of the problems mentioned above. The device is in the form of an inverted U-shaped tube with at least one of the opposed ends having opposed reservoirs for storing a reactant and an indicator with a wick employed to enable the reactant to contact the indicator thereby initiating a color change over a preselected period of time.

It would be an advance in the art of providing visible indicators for determining when a product should be replaced or rejuvenated if a cost efficient and effective shelf life indicator could be provided which provides a clear and distinct visible indication of when a product should be replaced or rejuvenated and does so without employing a wicking material so as to reduce the cost of the device. It would be a further advance in the art if a shelf life indicator could be provided which enables the consumer to see how much time is remaining for the shelf life of the product which indication is accurate and clearly visible.

### SUMMARY OF THE INVENTION

The present invention is generally directed to a shelf life indicator hereinafter referred to as a “timing device” for determining the remaining shelf life of a product and visually displaying the same which has applicability to a wide range of consumer products and packages containing the same. The timing device can be applied to products which have a relatively short shelf life (e.g. dairy products including milk) and products which have a fairly long shelf life such as canned vegetables.

In a particular aspect of the present invention, there is provided a timing device for determining and visually displaying the passage of a preselected period of time comprising:

a tube containing a first liquid and a second liquid in contact with the first liquid wherein one of the first and second liquids diffuse into the other of said liquids in a manner which results in an observable change in property, in which the extent of the observable change in property is related to the desired preselected period of time.

Methods of employing the device, packages employing the device and methods of manufacturing the device also constitute a part of the invention set forth herein.

### BRIEF DESCRIPTION OF THE DRAWINGS

The following drawings in which like reference characters indicate like parts are illustrative of embodiments of the invention and are not intended to limit the invention as encompassed by the claims forming part of the application.

FIG. 1 is a front elevational view of a first embodiment of a tube containing first and second liquids which is employed as part of the timing device of the present invention;

FIG. 2 is a respective front elevational view of the embodiment shown in FIG. 1 showing the progression of a color change arising from contact of the first and second liquids;

FIG. 3 is a front elevational view of another embodiment of the invention with a porous membrane between the first and second liquids;

FIG. 4 is a front elevational view of another embodiment of the invention in which the timing device has a U-shape;

FIGS. 5A and 5B are front elevational views of still further embodiments of the invention in which the timing device has a W-shape;

FIG. 6 is a perspective view of a timing device of the invention contained within a product package;

FIG. 7 is a perspective view of a timing device of the invention similar to that shown in FIG. 6 with individual windows showing a color change; and

FIG. 8 is a perspective view of a timing device similar to FIG. 7 with some windows showing a color change and other windows not showing a color change.

### DETAILED DESCRIPTION OF THE INVENTION

The present invention is generally directed to a timing device for visually determining the passage of a preselected period of time in which the timing device has particular applicability to visually indicating the remaining shelf life of a product, especially consumer products such as food products and household products. The main component of the timing device is a tube which contains two liquids, hereinafter referred to as first and second liquids in which the second liquid is in sufficient proximity to the first liquid so that one of the liquids may diffuse into the other liquid. Contact of the first and second liquids produces a visible change in at least one property, preferably a color change which can indicate that the product should be replaced or rejuvenated, the amount of time which has passed since the product was used, and/or the amount of time remaining before the product must be replaced or rejuvenated. Of particular importance to the present invention is the properties of the first and second liquids. When the respective liquids come into contact with each other, there is a gradual and controlled change of property, visible to the user, which encompasses the desirable preselected period of time.

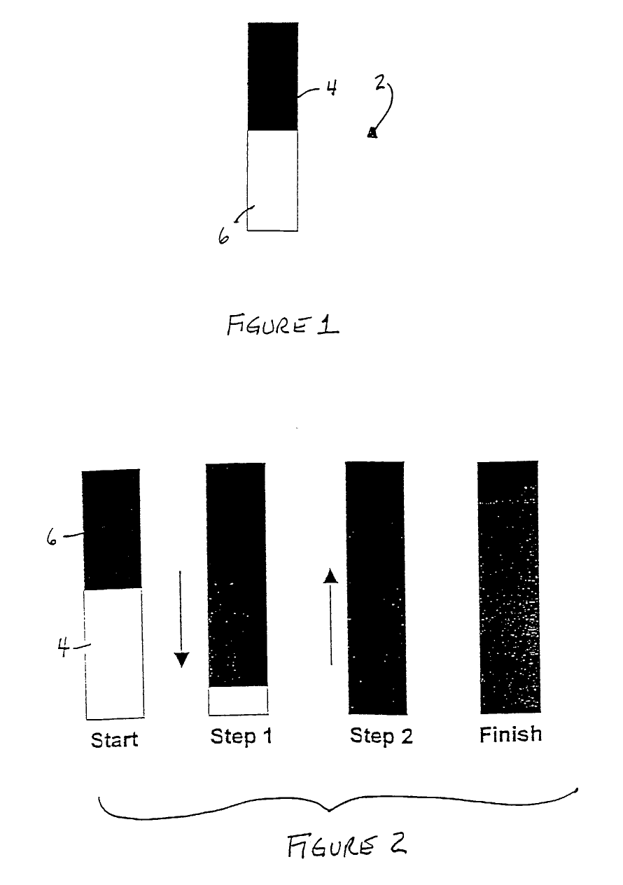

A first embodiment of the invention is shown in FIG. 1. There is shown tube 2 having therein a first liquid 4 and a second liquid 6 which as shown in FIG. 1 are in direct contact with each other or as described hereinafter may be separated by a porous barrier layer such as filter paper.

The tube 2 as shown in FIG. 1 can be fabricated from any number of materials including plastics and glass. It is preferred that the material used to construct the tube 2 be unbreakable to prevent injury to the consumer. Preferred materials are plastics including, for example, polyethylene and polyethylene terephthalate.

The tube 2 must enable the user to observe a change of property such as a color change that occurs within the tube. Thus, the term “clear” as used herein means that the tube must enable the user to visibly observe a change of property and is therefore typically transparent or translucent or the like, but typically not opaque. The tube 2 itself may be colored so long as the change of property (e.g. color change) taking place within the tube can be observed by the user.

The first and second liquids may be any liquids which enable one of the liquids to diffuse into the other liquid and as a result evidence a change of property which is observable by the user. It will be understood that the term liquid is broad enough to encompass gels, flowable semisolids and the like. One of the first and second liquids may be selected from, for example, acids, acid salts, bases, base salts, oxidizing agents and reducing agents. The other of the liquids may be selected from the same materials, typically one of opposite function. For example, if the first liquid is an acid or acid salt, the second liquid will be a base or base salt and the change in property will typically be a change in pH which manifests itself through a visible color change.

It will be understood that either or both of the first and second liquids may also contain an indicator. Indicators are those materials which when in contact with a liquid having a certain property (e.g. acidic pH) cause the change in property which is visible to the user. Typical indicators include, for example, litmus compounds, methyl orange, bromocresol green and congo red.

The change in property which results in a change observable by the user may be from the direct interaction of the indicator and reactant or through an intermediary substance. Direct interaction indicators are those which change color through direct contact with the reactant. Examples of direct indicators are so-called redox indicators such as thymolindolphenol and neutral red. Thymolindolphenol is colorless in its reduced form. Upon contact with a suitable oxidizing agent (e.g. Fe⁺³), thymolindolphenol is oxidized and thereby turns blue.

Neutral red is likewise colorless in reduced form. When oxidized in the presence of a suitable oxidizing agent, neutral red turns red. Other redox reactions may be employed to effect a visible color change including the conversion of CrO₂⁻ (green) to CrO₄⁻² (yellow).

The above-mentioned redox systems are examples of direct interaction systems. Such systems produce a change of property by direct reaction of the reactant and indicator.

In some reactant-indicator systems, it is possible to extend the time before the reactant and indicator react to produce a change of property by employing a scavenger for one of them. For example, a reactant (Fe⁺³), scavenger (Cu⁺¹) and indicator (e.g. thymolindolphenol) are contained within the timing device. Before the indicator can undergo a color change, the reactant first reacts with the scavenger. Alternatively, another method of obtaining a further delay is to initiate a series of reactions such that a first reactant and a co-reactant produce a first intermediate. The first intermediate can either react with the indicator or with a second co-reactant to produce second intermediate which second intermediate reacts with the indicator to produce a color change. Any number of intermediary reactions and intermediates may be employed as desired.

Other reactant-indicator pairs and scavengers used therewith are known and available such as the employment of a system including Ti⁺² (reactant), Fe⁺³ (scavenger) and neutral red (indicator).

In another reactant-indicator system, the reactant may be water which induces a color change from a reactant which is an anhydrous compound. For example, cobalt chloride is an anhydrous compound which is blue. Upon contact with water (reactant), the cobalt chloride converts to the hydrated form which has a pink color. Other anhydrous compounds which are suitable for use in the present invention would be known to those of ordinary skill in the art.

The timing device of FIG. 1 provides for the diffusion of one of the liquids into the other of the liquids with such diffusion and resultant contact producing a gradual and controllable visible change of property such as a color change. In one embodiment of the invention as shown in FIG. 2, the second liquid which is placed above the first liquid in a tube will diffuse downwardly into the first liquid as indicated by “Step 1” resulting in a color change. Once all of the first liquid has undergone a color change, the color change will move progressively up the tube as shown in “Step 2” so that the second liquid undergoes a color change as well. Once the contents of entire tube have undergone the color change (i.e. “Finish”), the timing device can no longer measure the passage of time. It will be understood that the timing device need not show a complete color change as shown at the “Finish” step if the preselected period of time measurement is encompassed by Step 1 or the combination of Steps 1 and 2.

As used herein the term “tube” shall mean any elongated vessel regardless of cross-sectional shape in which the diffusion of liquids may take place as described herein. The cross-sectional shape of the tube may vary and includes, but is not limited to, any polygonal shape (including square, rectangle, triangle, pentagon, hexagon, octagon and the like) as well as a circular cross-section which is a preferred shape.

In accordance with the present invention, a viscosity modifying agent may be added either to the first liquid or to the second liquid or to both. The viscosity modifying agent, depending on its viscosity, can be used to speed up or slow down the rate of travel of the first and second liquids. The slowing down of the travel time is desirable when the shelf life of the product is relatively long. The speeding up of the travel time is desirable for those products having a relatively short shelf life.

Viscosity modifying agents for use in the present invention are desirably compatible with the other components the first and/or second liquids in that they do not cause any change in the composition of the components or the manner in which they react with each other. Still further, it is desirable that the viscosity modifying agent be nontoxic, particularly when associated with products used by consumers. Typical examples of viscosity modifying agents for use in the present invention include water, glycerine, alkylene glycols (e.g. propylene glycol), hydroxyalkyl celluloses (e.g. hydroxyethyl cellulose), cellulosic polymers, acrylic polymers, polyacrylates, carboxyalkylcelluloses and combinations thereof.

The amount of the first and second liquids, and optional viscosity modifying agent may vary. The amounts selected for each of the components are made to ensure a visible change in property after a desirable preselected period of time (i.e. the length of the time of the shelf life of the product). The amount of each of these components should be sufficient to provide a progressively changing visible change of property readily observed by the user. This represents a minimum amount of the components to achieve the desired time period measurement. More than the minimum amount of each component can be used to ensure a desirable rate of change of property over the length of the timing device to coincide with the preselected time period. Generally, the amount of the first liquid active agent (e.g. an acid or acid salt) is at least 0.01% by weight and most typically from about 0.01 to 5.0% by weight, based on the total weight of the materials of the reactant solution. The amount of the second liquid active agent (e.g. base or base salt) is typically at least 0.01% by weight, most typically within the range of from about 0.01 to 5.0% by weight and the amount of the viscosity modifying agent, if necessary, may approach 100% by weight of the first and/or second liquid and is typically in the range of from about 15 to 75% by weight based on the weight of the respective solution.

The amount of the first and second liquids contained within a tube or other housing may vary such that one of the liquids is typically present in an amount of 10 to 90% the length of the tube while the other of the liquids makes up the balance (i.e. 90 to 10%).

Another factor which can be employed to control the rate at which the change of property occurs is the selection of first and second liquids according to their solubility parameters. A complete explanation of solubility parameters is set forth in Stephen L. Rosen, Fundamental Principles of Polymeric Materials, pp. 88-91, (1993), incorporated herein by reference.

In general, the solubility parameter of a liquid is a function of the internal energy of vaporization of the liquid owing to hydrogen bonds, dipole interactions and dispersion forces (e.g. Van der Waals). Thus, the solubility parameter δ may be considered as a vector in three dimensions d, p and h. The magnitude of the vector may therefore be represented by the equation.

δ²=δ²d+δ²p+δ²h

Liquids which have more similar solubility parameters generally diffuse into each other faster than liquids which have less similar solubility parameters and thus the observable change of property will be extended over a shorter period of time than liquids with dissimilar solubility parameters.

By way of example, Table 1 shows the solubility parameters for water, glycerol and propylene glycol.

TABLE 1
Solubility Parameters (MPa)^{½}

| | δ_{d} | δₚ | δₕ | δ overall |
|---|---|---|---|---|
| Water | 15.5 | 16.0 | 42.4 | 47.9 |
| Glycerol | 17.4 | 12.1 | 29.3 | 36.2 |
| Propylene | 16.8 | 9.4 | 23.3 | 30.3 |
| Glycol | | | | |

As shown in Table 1, water and glycerol are generally more compatible than the combination of water and propylene glycol. Accordingly, the selection of glycerol and water as first and second liquids should be made if a relatively shorter period of time to observe the change of property is desired as compared with the selection of propylene glycol and water as the first and second liquids In another embodiment of the invention as shown in FIG. 3, the tube 2 is provided with a porous barrier 10 which slows the rate at which one of the liquids diffuses into the other liquid. The porous barrier may be made of any material which facilitates diffusion but at a slower rate than would be obtained in the absence of the porous barrier 10. Examples of suitable materials for the porous barrier include polyesters, polyacrylates, polyacrylamides, polypropylene, polyethylene terephthalate and copolymers thereof, cellulosic materials (including but not limited to natural or synthetic cotton, wood, paper and cellulosic polymers), wool, fiberglass, silica gel, ceramics and combinations thereof.

The density of the porous barrier may be a factor in controlling the rate of diffusion. Generally, the denser the porous barrier, the slower the rate of diffusion. By selecting a suitable porous barrier material, and density thereof, one is able to control the rate of diffusion of the liquids.

The tube employed to house the first and second liquids need not be in the form shown in FIGS. 1-3. As shown in FIG. 4, the tube designed by the numeral 20 may have a U-shape with a pair of opposed leg portions with one of the leg portions housing one of the first and second liquids while the other leg portion may contain the other liquid.

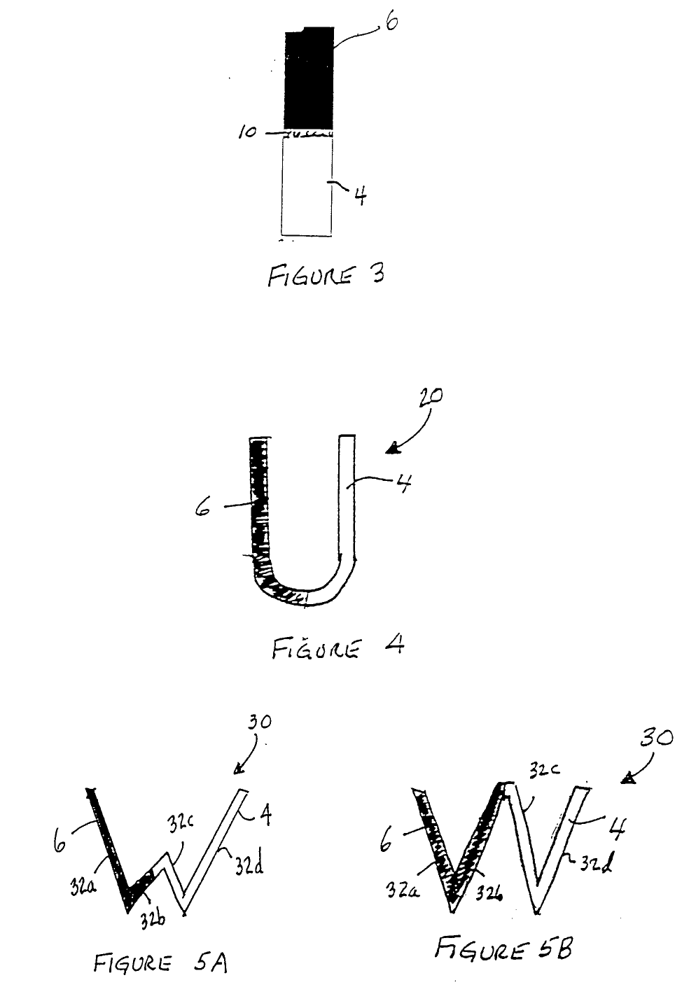

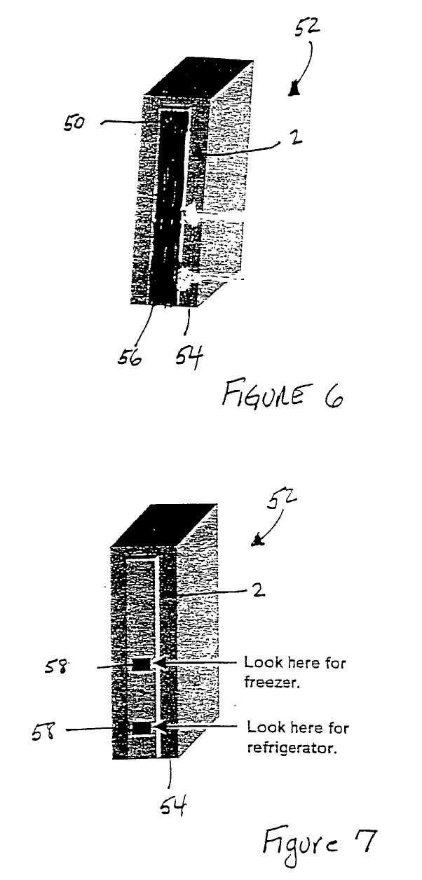

In a further embodiment of the invention, the tube may have a W-shape as shown in FIGS. 5A and 5B. The tube 30 in this embodiment has four leg portions 32a-32d (outer leg portions 32a and 32d and inner leg portions 32b and 32c) and each may contain either the first or second liquids. Because the path of diffusion in the embodiment of FIG. 4 is more arduous owning to the multiple bends, the embodiments of FIGS. 5A and 5B may be desirably used for particular lengthy preselected periods of time. It will be noted that the embodiment of FIG. 5A favors a shorter preselected period of time as compared with the embodiment of FIG. 5B owing to the relatively shorter length of the inner leg portions 32b and 32c.

Referring to FIG. 6, there is shown an embodiment of the timing device shown in FIGS. 1-3 contained within a housing 50 of a package 52 which contains a consumer product. The housing 50 provides sufficient space to house the timing device 2. The housing 50 has a front face 54 with a clear window 56 enabling the viewer to view the entire timing device 2. In this embodiment of the invention, the user can view the entire timing device 2 as discussed above in connection with FIGS. 1-3. Thus, all color changes and the location of all color changes can be observed by the user.

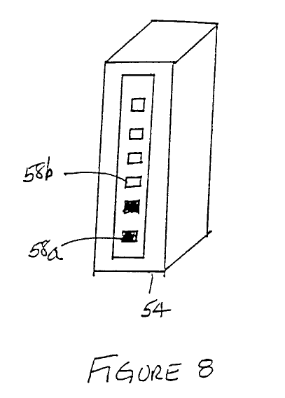

In another embodiment of the invention as shown in FIG. 7, the package 52 may be provided with a housing 50 in which the front face 54 contains one or more ports or windows 58 which shows periodic color changes through the window indicating the passage of a fixed period of time such as one week or one month which may be associated with a particular place of use (e.g. freezer or refrigerator). If only one window is used, it should be at the point that there is a final color change indicating that the product needs to be replaced or rejuvenated. The employment of multiple windows 58 enables the user to periodically observe how much time has passed and how much time remains of the product shelf life. In the specific embodiment of FIG. 8, there are six windows with the first two windows 58a indicating a color change and the last four windows 58b not yet indicating a color change. If each window was indicative of the passage of one week of time, then the product would have been used for two weeks with about four weeks remaining of the product shelf life.

The timing device 2 of the present invention can be affixed to a product by adhesive or the like or can become prepackaged with the product as indicated in the embodiments of FIGS. 6 and 7. In some cases, it is desirable to package the first and second liquids in the tube within a breakable container which can be broken by pressure applied to the user. Such containers include capsules made of a variety of materials including gelatins and the like. The breakable capsules enable the user to commence the start of the product life and thereby disregard the period of time from manufacture to purchase by the user.

### EXAMPLE 1

A timing device of the type shown in FIG. 1 was constructed by providing a 60 mm tube with a 30 mm column of a first liquid (provided in the bottom of the tube) having the composition shown in Table 2 and a 30 mm column of a second liquid having the composition shown in Table 2.

TABLE 2

| | % by weight | |
|---|---|---|
| | Second Liquid | First Liquid |
| Component | (Viscosity = 48,000 CP) | (Viscosity = 40,000 CP)** |
| Water | 48.1 | 48.3 |
| Glycerin | 48.1 | 48.3 |
| Propylene glycol | — | — |
| Hydroxyethyl | 2.6 | 2.0 |
| cellulose* | | |
| Thymol Blue | 0.2 | — |
| Sodium | 1.0 | — |
| phosphate | | |
| Citric acid | — | 1.4 |
| monohydrate | | |

*Natrasol 250M manufactured by Aqualon division of Hercules, Inc.
**Viscosity measured with a Brookfield DV-II and Viscometer at 5 pm, using spindle E.

The tube was placed in a refrigerator at 40° F. and the time required fo the entire length of the tube to change color (i.e. orange) was between 62 and 70 days.

### EXAMPLE 2

The procedure of Example 1 was repeated except that the second liquid contained only 47.6% by weight of each of water and glycerin and 3.6% by weight of hydroxyethyl cellulose and had a viscosity of 450,000 CP. The first liquid contained only 47.8% by volume of each of water and glycerin and 3.0% by weight of hydroxyethyl cellulose and had a viscosity of 116,000 CP.

The entire tube employed for Example 2 underwent a color change between 74 and 82 days. Thus, by increasing the amount of hydroxyethyl cellulose the rate of diffusion was reduced and the resultant color change took longer to achieve.

### EXAMPLE 3

The procedure of Example 1 was repeated except that the second liquid contained 47.6% by weight of water and 23.8 weight % of each of glycerin and propylene glycol. The viscosity of the second liquid was 133,000 CP. The first liquid contained 47.8% by weight of each of water and glycerin while the amount of hydroxyethyl cellulose was increased to 3.0% by weight. The viscosity of the first liquid was 116,000 CP. The entire tube underwent a color change between 80 and 88 days.

### EXAMPLES 4 AND 5

A timing device of the type shown in FIG. 4 was provided with first and second liquids having the composition shown in Table 3.

TABLE 3

| | % of weight | |
|---|---|---|
| | Second Liquid | First Liquid |
| Component | (Viscosity = 450,000 CP) | (Viscosity = 116,000 CP)** |
| Water | 47.6 | 47.8 |
| Glycerin | 47.6 | 47.8 |
| Propylene glycol | — | — |
| Hydroxyethyl | 3.6 | 3.0 |
| cellulose* | | |
| Thymol Blue | 0.2 | — |
| Sodium | 1.0 | — |
| phosphate | | |
| Citric acid | — | 1.4 |
| monhydrate | | |

*Natrasol 250M
**Viscosity measured with a Brookfield DV-II and Viscometer at 5 pm, using spindle E.

The porous barrier provided between the first and second liquids for Example 4 was Whatman #4 Filter paper while the porous barrier for Example 5 was VWR320 Blotter paper manufactured by VWR Scientific, Inc.

The time required for the tube of Example 4 to turn completely orange was 84 to 92 days, while the time required for the tube of Example 5 to exhibit the same color change was 86 to 94 days.

### EXAMPLE 6

A 60 mm long timing device as shown in FIG. 4 was provided with first and second liquids having the respective compositions shown in Table 3. The first liquid was provided on the bottom of the device to a height of 50 mm. The second liquid was placed on top of the first liquid (i.e. to a height of 10 mm). A porous barrier of VWR 320 blotter paper separated the two liquids. The viscosity of the first and second liquids was the same as that set forth in Examples 4 and 5.

The length of the tube showing the color change was (i.e. the bandwidth of the color change) measured as a function of time and the results are shown in Table 4.

TABLE 4

| Days | 20 | 40 | 60 | 70 | 90 |
|---|---|---|---|---|---|
| Bandwidth (mm) | 8 | 19 | 28 | 34 | 36 |

What is claimed is:

1. A timing device for visually determining the passage of a preselected period of time comprising:
a tube containing a first liquid and a second liquid in contact with the first liquid, wherein one of the first or second liquids diffuses into the other of said liquids in a manner which results an observable change in a property in which the extent of the observable change in property is related to said preselected period of time.

2. The timing device of claim 1 wherein the observable change in property is a color change.

3. The timing device of claim 2 wherein one of the first and second liquids has a pH of greater than 7 and the other of the first and second liquids has a pH of less than 7.

4. The timing device of claim 2 wherein one of the first liquid and the second liquid is an acid or acid salt and the other said first and second liquids is a base or basic salt.

5. The timing device of claim 2 wherein one of said first and second liquids contains a color change indicator.

6. The timing device of claim 1 further comprising a porous membrane between the first and second liquid.

7. The timing device of claim 1 wherein the height of the first liquid in the tube is different than the height of the second liquid in the tube.

8. The timing device of claim 4 wherein the first and second liquids have different viscosities.

9. The timing device of claim 6 wherein the viscosity of the first liquid is greater than the viscosity of the second liquid.

10. The timing device of claim 7 wherein the viscosity of the first liquid is less than the viscosity of the second liquid.

11. The timing device of claim 1 wherein at least one of the first and second liquids contains a viscosity modifying agent.

12. The timing device of claim 9 wherein the viscosity modifying agent is selected from the group consisting of water, glycerine, alkylene glycols and mixtures thereof.

13. The timing device of claim 9 wherein the porous membrane comprises a filter paper.

14. The timing device of claim 1 wherein the first and second liquids have different solubility parameters.

15. The timing device of claim 1 wherein the tube has a circular cross-section.

16. The timing device of claim 1 wherein the tube is linear.

17. The timing device of claim 1 wherein the tube has at least one bend.

18. The timing device of claim 1 wherein the tube is U-shaped.

19. The timing of device of claim 1 wherein the tube is W-shaped.

20. The timing device of claim 19 wherein the W-shaped tube comprises a pair of outer leg portions and a pair of inner leg portions with the outer leg portions being approximately the same length as the inner leg portions.

21. The timing device of claim 19 wherein the W-shaped tube comprises a pair of outer let portions and a pair of inner leg portions with the outer leg portions having a length greater than the length of the inner leg portions.
